(19) United States
(12) Patent Application Publication
(10) Pub. No.: US 2025/0208975 A1
(43) Pub. Date: Jun. 26, 2025

(54) NOTIFICATION SYSTEM FOR DELEGATING CODE REVIEW TASKS

(71) Applicant: Interwise Ltd., Airport City (IL)

(72) Inventors: Sharon Eitan, Shoham (IL); Ram Marzin, Kfar Harif (IL); Snir Bandela, Ganey Tikva (IL); Tamar Ayalon-Zur, Ramat Ha-Sharon (IL)

(21) Appl. No.: 18/395,459

(22) Filed: Dec. 22, 2023

(51) Int. Cl. G06F 11/36

(52) U.S. Cl. CPC G06F 11/3608

(57) ABSTRACT

A method for generating notifications for delegating code review tasks includes detecting a request for a code change to be merged into a main repository for a source code, determining, based on an analysis of the code change, an estimated risk level of the code change, predicting, based on the analysis of the code change, an estimated amount of time needed to review the code change, identifying, based on the analysis of the code change and on an analysis of the request, an individual to whom to assign the code change for review, generating a notification that includes a description of the code change and the estimated amount of time, and delivering the notification to the individual.

The present disclosure relates generally to software development, and relates more particularly to devices, non-transitory computer-readable media, and methods for generating notifications for delegating code review tasks.

### BACKGROUND

Code review is a step of the software development process in which the source code of a software program is manually reviewed by one or more human reviewers other than the person who authored the source code. For instance, different portions of the source code may be reviewed by different members of a software development team. Code review is considered vital for enhancing collaboration among members of a software development team, helping the members of the software development team learn new technologies and techniques from each other, ensuring that the source code meets any applicable requirements and standards before the source code is merged or deployed, maintaining a consistent code style and structure across the software development process, identifying and fixing errors in the source code, and fostering an environment for brainstorming and developing creative solutions.

### SUMMARY

In one example, the present disclosure describes a device, computer-readable medium, and method for generating notifications for delegating code review tasks. For instance, in one example, a method performed by a processing system including at least one processor includes detecting a request for a code change to be merged into a main repository for a source code, determining, based on an analysis of the code change, an estimated risk level of the code change, predicting, based on the analysis of the code change, an estimated amount of time needed to review the code change, identifying, based on the analysis of the code change and on an analysis of the request, an individual to whom to assign the code change for review, generating a notification that includes a description of the code change and the estimated amount of time, and delivering the notification to the individual.

In another example, a non-transitory computer-readable medium stores instructions which, when executed by the processing system, cause the processing system to perform operations. The operations include detecting a request for a code change to be merged into a main repository for a source code, determining, based on an analysis of the code change, an estimated risk level of the code change, predicting, based on the analysis of the code change, an estimated amount of time needed to review the code change, identifying, based on the analysis of the code change and on an analysis of the request, an individual to whom to assign the code change for review, generating a notification that includes a description of the code change and the estimated amount of time, and delivering the notification to the individual.

In another example, a system includes a processing system including at least one processor and a non-transitory computer-readable medium storing instructions which, when executed by the processing system, cause the processing system to perform operations. The operations include detecting a request for a code change to be merged into a main repository for a source code, determining, based on an analysis of the code change, an estimated risk level of the code change, predicting, based on the analysis of the code change, an estimated amount of time needed to review the code change, identifying, based on the analysis of the code change and on an analysis of the request, an individual to whom to assign the code change for review, generating a notification that includes a description of the code change and the estimated amount of time, and delivering the notification to the individual.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for generating notifications for delegating code review tasks may operate;

FIG. 2 illustrates a flowchart of an example method for generating notifications for delegating code review tasks; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for generating notifications for delegating code review tasks. As discussed above, code review is a step of the software development process in which the source code of a software program is manually reviewed by one or more human reviewers other than the person who authored the source code. For instance, different portions of the source code may be reviewed by different members of a software development team. Code review is considered vital for enhancing collaboration among members of a software development team, helping the members of the software development team learn new technologies and techniques from each other, ensuring that the source code meets any applicable requirements and standards before the source code is merged or deployed, maintaining a consistent code style and structure across the software development process, identifying and fixing errors in the source code, and fostering an environment for brainstorming and developing creative solutions.

Despite the many benefits of code review, the manner in which code review tasks are typically coordinated leaves much room for improvement. For instance, because code review is largely a manual process, there is no guarantee that an individual who is selected to perform a code review task is actually the individual who is best suited to perform the task. Moreover, even when the individual who is selected to perform the code review task is the individual who is best suited to perform the task, there is no guarantee that the individual will or is able to perform the code review task in a timely manner. As a result, source code may end up being reviewed by an individual with little to no expertise in the relevant code (which may harm code quality or result in only a high level review for obvious bad code practices that misses more subtle risks), by an individual who cannot devote adequate time for more than a basic review of the source code (which may also result in risks being missed), by an individual who may not be able to review the source code in a timely manner (which may result in a delay in deployment and/or conflicts with code merges that have been completed in the meantime), and/or by an individual who is unaware of any risks or issues that are specific to the source code being reviewed.

Examples of the present disclosure provide modifications to the pull request, which is typically part of the overall code review process. A pull request is a way to request that a code change be merged into the main project repository for a software development project, and is typically issued through a source code management tool. A pull request normally includes at least a description of the code change, the origin and target branches of the code change, a list of individuals who are authorized to approve or reject the pull request, and the changes the code change introduces into the source code (with any additions and deletions introduced by the changes marked up). Pull requests are useful tools for encouraging collaboration among members of a software development team and ensuring that code changes are ready to be implemented into a software development project. Pull requests also allow code change authors and reviewers to discuss and comment on the code changes and to make further changes if needed. Once a pull request is approved by at least one individual who is authorized to approve or reject the pull request, the code change can be merged into the target branch of the source code. If, however, the pull request is rejected by at least one individual who is authorized to approve or reject the pull request, the author of the code change may be encouraged to resubmit the pull request after making any necessary changes to the code change.

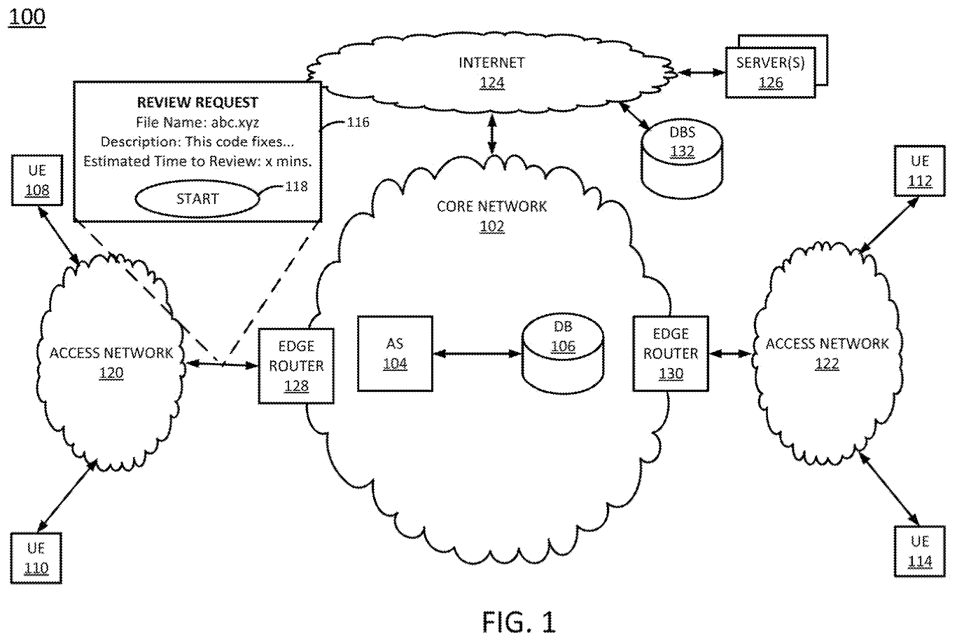

In one example of the present disclosure, a pull request containing a code change may be analyzed in order to estimate a risk level associated with the code change and an amount of time needed to review the code change, as well as to identify one or more individuals who are well suited to review the code change based on the estimated risk level and amount of time needed to review. A notification may then be generated and sent to at least one identified individual, where the notification includes not only the code change to be reviewed, but also an indication of the estimated risk level and amount of time needed to review. In further examples, the notification may include a feedback mechanism that helps to track the review process. By selecting the individual who is best suited to review the source code and providing that individual with the information contained in the notification, it is expected that the challenges faced by conventional code review processes (such as delays in review due to lack of familiarity with the source code and/or lack of awareness of the urgency of the review) can be significantly reduced. As a result, the final software product may be delivered more quickly and with fewer bugs, while making more efficient use human resources. These and other aspects of the present disclosure are discussed in further detail with reference to FIGS. 1-3, below.

To further aid in understanding the present disclosure, FIG. 1 illustrates an example system 100 in which examples of the present disclosure for generating notifications for delegating code review tasks may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

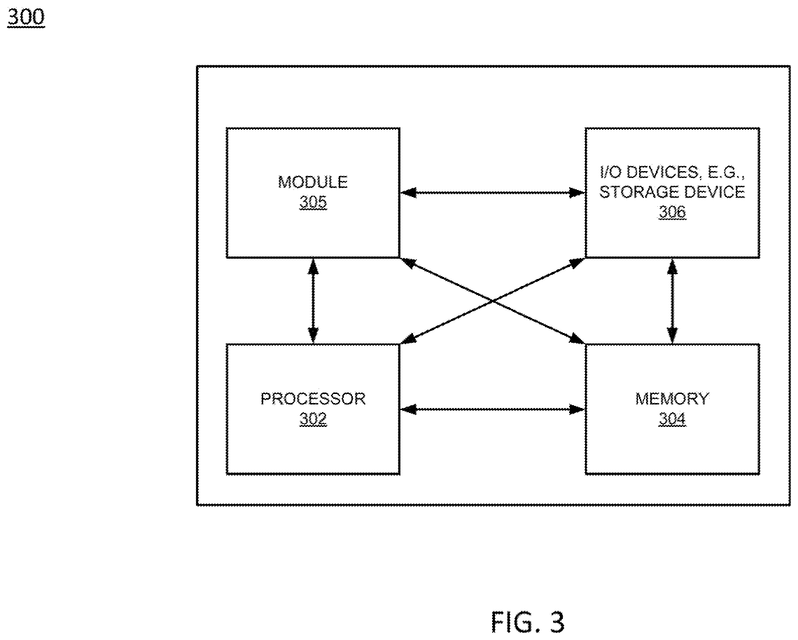

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 300 depicted in FIG. 3, and may be configured as described below. For example, the user endpoint devices 108, 110, 112, and 114 may each comprise a smart phone, a tablet computer, a laptop computer, a gaming device, a wearable smart device (e.g., a smart watch, a head mounted display, or the like), an IoT device, a bank or cluster of such devices, and the like. In one example, any one of the user endpoint devices 108, 110, 112, and 114 may be operable to run an application that may communicate with the server(s) 126 or other application servers in the system 100, as discussed in greater detail below.

In one example, one or more servers 126 and one or more databases 132 may be accessible to user endpoint devices 108, 110, 112, and 114 via Internet 124 in general. The server(s) 126 and DBs 132 may be associated with Internet software applications that may exchange data with the user endpoint devices 108, 110, 112, and 114 over the Internet 124. In one example, at least some of the servers 126 and DBs 132 host applications that manage review of code changes by generating notifications for delegating code review tasks.

In accordance with the present disclosure, the AS 104 may be configured to provide one or more operations or functions in connection with examples of the present disclosure for generating notifications for delegating code review tasks, as described herein. For instance, in one example, the AS 104 may monitor a main repository for a source code, where the source code may comprise source code for a software program that is under development. The main repository may comprise, for instance, the DB 106 or the DB 132.

When the AS 104 detects a request for a code change to be merged into the main repository (e.g., a pull request), the AS 104 may initiate a process that attempts to determine more information about the code change, so that a review of the code change can be assigned to an individual who can review the code thoroughly and in a timely manner. For instance, detection of the request by the AS 104 may cause the AS 104 to perform a risk analysis of the code change in order to estimate a risk level of the code change (e.g., where the risk level may indicate the likelihood of a bug being present in the code change). Based on the estimated risk level, the AS 104 may then evaluate one or more individuals (e.g., candidates) to whom the code change may be assigned for review. For instance, if the estimated risk level is relatively high (e.g., above a predefined threshold), then it may be more prudent to assign the code change to a more experienced software developer. However, if the estimated risk level is relatively low (e.g., below the predefined threshold), then it may be worthwhile to assign the code change to a less experienced software developer, so that the less experienced software developer may improve their code review skills and/or learn new technology.

In one example, at least one of the DBs 106 or 132 may contain profiles associated with individuals who are members of a software development team. The profile for a given individual may identify the individual (e.g., by name, email address, identifying number, or other identifiers) and may further contain information about the extent of the individual's software development experience (e.g., number of years performing software development, number of software development and/or code review tasks performed, nature of software development and/or code review tasks performed, areas of software development expertise, such as fields of technology, code functions, programming languages, any coding credentials or certifications received, or the like) and the number of code review tasks currently assigned to the individual by the AS 104. The information contained in the profile may help the AS 104 to narrow down the candidates to whom the code change may be assigned to a shorter list of individuals who are best suited to review the code change, based on the nature and risk level of the code change. In a further example, the AS 104 may consider the current workloads of the candidates (e.g., the number of code review tasks currently assigned to each of the candidates) when narrowing down the candidates. For instance, if the code change must be reviewed relatively quickly, it may not be prudent to assign the review to an individual who already has a long list of code review tasks to complete.

Once the AS 104 has selected an individual to whom to assign the code change for review (e.g., potentially with input from the author of the code change), the AS 104 may generate a notification via which to assign the code review to the individual. An example notification 116 is illustrated in FIG. 1. The notification may be sent to a UE 108, 110, 112, or 114 of the individual who is selected.

In one example, the notification 116 may include a machine learning-generated description of the code change (which may be more detailed than a description contained in the initially detected request). The notification may additionally include an estimated amount of time needed to review the code change and an explanation as to why the individual was selected to perform the review of the code change. In a further example, the notification may include a button 118 or other objects that may include an embedded hyperlink, where activating of the embedded hyperlink by the individual may immediately initiate a code review process for the code change. When the embedded hyperlink is activated, the AS 104 may be notified, so that the AS 104 may track the progress of the review of the code change.

The AS 104 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the DB 106 may comprise a physical storage device integrated with the AS 104 (e.g., a database server or a file server), or attached or coupled to the AS 104, in accordance with the present disclosure. In a further example, the DB 106 may contain code changes that need to be reviewed and copies of notifications that were sent to UEs 108, 110, 112, or 114 to assign code review tasks.

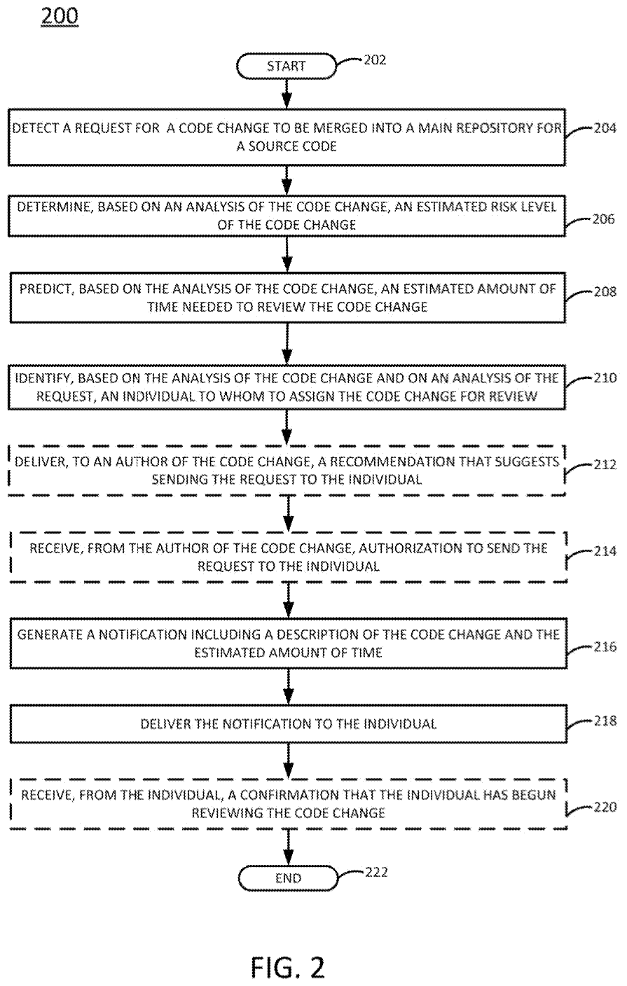

In one example, the AS 104 may load instructions into a memory, or one or more distributed memory units, and execute the instructions for communicating maximum values for generating notifications for delegating code review tasks may operate, as described herein. For instance, an example method for generating notifications for delegating code review tasks may operate is discussed in further detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

To further aid in understanding the present disclosure, FIG. 2 illustrates a flowchart of an example method 200 for generating notifications for delegating code review tasks. In one example, the method 200 may be performed by the AS 104 or by another element of the core network 102 illustrated in FIG. 1. However, in other examples, the method 200 may be performed by another device, such as the computing system 300 of FIG. 3, discussed in further detail below. For the sake of discussion, the method 200 is described below as being performed by a processing system (where the processing system may comprise a component of the AS 104 or by another element of the core network 102, the computing system 300, or another device).

The method 200 begins in step 202. In step 204, the processing system may detect a request for a code change to be merged into a main repository for a source code.

In one example, the request for the code change may comprise a pull request, where the pull request is a part of the code review process for a software program that the source code is associated with. Thus, the pull request may include at least one of the following: a description of the code change, an origin branch of the code change in the source code, a target branch of the code change in the source code, a list of one or more individuals who are authorized to approve or reject the pull request, or the actual changes to the source code that are introduced by the code change (where any additions or deletions to the source code that are introduced by the code change are marked up or tracked).

In step 206, the processing system may determine, based on an analysis of the code change, an estimated risk level of the code change. In one example, the estimated risk level indicates a likelihood that a bug may be present in the code change. The likelihood may be expressed as a numerical likelihood (e.g., percentage, on a scale from one to ten, etc.) or as a range (e.g., low, medium, or high risk).

In one example, the processing system may execute a code analysis routine that always runs in the background on every piece of source code that is integrated into a software development project. In one example, the code analysis routine may extract data from the request received in step 206 and provide the extracted data as input to a machine learning model (e.g., a support vector machine, a linear regression model, a neural network, a random forest model, or the like). In one example, the data that is extracted from the request and provided to the machine learning model as input includes at least one of: the author of the code change, the individual (if any) to whom the request is directed for review of the code change, a timestamp indicating when the request was received by a ticketing system that manages pull requests, a list of files attached to the request, and line numbers in each of the files attached to the request. In one example, similar data may be extracted from historical requests received by the ticketing system (i.e., requests that were received by the ticketing system prior to the receipt of the request detected in step 204) and also provided as input to the machine learning model.

In one example, the machine learning model may determine the estimated risk level based on additional data inputs that are not extracted from the request, but from other data sources. In one example, these other data sources include the ticketing system that manages pull requests and a security scan tool that performs security scans on pull requests. In one example, data inputs that are extracted from the ticketing system may include at least one of: a work item type associated with the request, a bug status of the request (e.g., how many bugs have been automatically detected in the code change), or a severity of any bugs that have been automatically detected in the code change). In one example, data inputs extracted from the security scan tool may include at least one of: a security issue detected by the security scan tool or a severity of a security issue detected by the security scan tool.

The machine learning model may process any inputs provided and may generate as an output the estimated risk level of the code change. In one example, the estimated risk level may be estimated by evaluating one or more risk factors in connection with the code change. The risk factors that are evaluated may comprise at least one of: whether bugs have been detected in historical instances of source code that are similar to the code change (e.g., directed to the same field of technology or same function), the number of different individuals who worked on the code change, the type of the technology to which the software program is directed, or whether security scan tools have reported open issues in the code change.

Although the above describes using machine learning to generate the estimated risk level, in other examples, a rule-based approach may weigh one or more risk factors to generate an estimated risk level. However, using machine learning may have the added advantage of being able to differentiate between different software development projects, whose risk levels may depend on different rule sets.

In step 208, the processing system may predict, based on the analysis of the code change, an estimated amount of time needed to review the code change. In one example, the estimated amount of time may be calculated based on the number of lines of code that are changed in the code change and the file type of the code change. For instance, a rule may be defined that assigns a predefined amount of time per changed line of code. As an example, some best practices for code review suggest that no more than five hundred lines of code should be reviewed per hour (which translates to little more than eight lines per minute). Thus, according to this example, an estimated amount of time to review a code change of 100 lines may be approximately thirteen minutes. However, in some examples, the predefined amount of time that is assigned by the rule may be configurable to encourage quicker review, more careful review, or the like.

In step 210, the processing system may identify, based on the analysis of the code change and on an analysis of the request, an individual to whom to assign the code change for review. In one example, the estimated risk level determined in step 206 may influence the identification of the individual to whom to assign the code. For instance, if the estimated risk level is above a predefined threshold (e.g., the estimated risk level is considered relatively “high”), then it may be preferable to assign the code change to an individual who is an experienced software developer and/or has particular experience with the type of the technology to which the software program is directed or with the type of functions that the code change is directed to. Conversely, if the estimated risk level is below the predefined threshold (e.g., the estimated risk level is considered relatively “low”), then this may be a good opportunity to assign the code change to an individual who is less experienced and is trying to improve their skills and knowledge. Information about different individuals' experience, areas of expertise, and the like may be maintained in profiles that are stored in a database that is accessible to the processing system.

In one example, the processing system may rank a plurality of individuals for whom profiles are available. For instance, if the processing system determines based on the risk level that the individual should be an experienced software developer, then the processing system may identify a predefined number (e.g., x) of individuals who are, according to their profiles, the most experienced (e.g., most number of years of experience, most number of times performing code review, or the like). In one example, these individuals may be ranked from most experienced to least experienced. Alternatively, if the processing system determines based on the risk level that the individual should be a relatively new software developer, then the processing system may identify a predefined number (e.g., x) of individuals who are, according to their profiles, the least experienced (e.g., fewest number of years of experience, fewest times performing code review, or the like). In one example, these individuals may be ranked from the least experienced to the most experienced.

In a further example, identifying the individual to whom to assign the code change may also consider the current workloads of the individuals who may be considered for the review. For instance, in one example, if the top ranked individual currently has more than a threshold number of code review tasks (e.g., pull requests) assigned to them, then the second highest ranked individual may be preliminarily selected for assignment of the code change; if the second highest ranked individual also currently has more than a threshold number of code review tasks assigned to them, then the third highest ranked individual may be preliminarily selected for assignment of the code change; and so on. Thus, identifying the individual in accordance with step 210 may involve identifying the highest ranked individual (or number of individuals) whose current workload does not exceed the threshold number of code review tasks.

In another example, identifying the individual may involve identifying the individual who wrote the original code that the code change would override. For instance, the author of the original code that the code change would override may have the best understanding of the context and purpose behind the original code and may therefore have the best understanding as to how the code changes will affect the original code within the overall scope of the software development project.

In optional step 212 (illustrated in phantom), the processing system may deliver, to an author of the code change, a recommendation that suggests sending the request to the individual. For instance, as discussed above, the processing system may generate a recommendation that identifies the highest ranked individual (or number of individuals) whose current workload does not exceed the threshold number of code review tasks. If the recommendation identifies more than one individual, the recommendation may further ask the author of the code change to select one of the recommended individuals, to reject all of the recommended individuals, or to suggest an alternative individual who may not be identified in the recommendation. If the recommendation identifies a single individual, the recommendation may further ask the author of the code change to approve sending the request to the recommended individual, to reject sending the request to the recommended individual, or to suggest an alternative individual who may not be identified in the recommendation.

In optional step 214 (illustrated in phantom), the processing system may receive, from the author of the code change, an authorization to send the request to the individual. As discussed above, the author may accept or select the suggestion of the individual in the recommendation, may reject the suggestion of the individual, or may suggest an alternative individual. If the author accepts or selects a suggested individual, or suggests an alternative individual, then the method 200 may immediately proceed to step 216. However, if the author rejects all selected individuals in the recommendation and does not provide a suggestion of an alternative individual, then the processing system may repeat steps 210-212 in order to generate a new list of suggested individuals to whom to send the request.

In step 216, the processing system may generate a notification that includes a description of the code change and the estimated amount of time. In one example, the description of the code change may be generated using a generative machine learning technique (e.g., a generative adversarial network, a generative pre-trained language model, or the like). The generative machine learning technique may take as an input a description of the code change that is provided by the author of the code change in the request that is detected in step 204 (which is typically one or two sentences) and may generate as an output a more detailed description of the code change. The more detailed description may describe why the changed lines of code in the code change were changed, and what the changes are intended to accomplish. In a further example, the description of the code change may further include the size of the code change (e.g., the number of lines of code that have been changed in the code change).

In a further example, the notification may include a brief explanation as to why the individual was selected to review the code change. For instance, any considerations taken into account in conjunction with steps 210-214 (e.g., risk level of the code change, experience of the individual, selection by the author of the code change, etc.) may be enumerated in the notification. Providing the individual with an explanation as to why he or she was selected to review the code change may encourage more timely cooperation from that individual, since he or she will know that his or her selection was not arbitrary.

In a further example, the notification may include a button or other objects that include an embedded hyperlink, where the embedded hyperlink, when activated, initiates a review process for reviewing the code change. For instance, the hyperlink may cause an application on the individual's computing device to open a file containing the code change. As an example, the notification may include a button that reads “Start Review Now.” The inclusion of the button or object including the embedded hyperlink may encourage quicker turnaround in the code review process, or discourage procrastination, by providing a mechanism by which the code review process can easily be started.

In step 218, the processing system may deliver the notification to the individual. For instance, the notification may be delivered to the individual's email, to the individual's mobile device (e.g., via text message), or via a software application through which a software development team may collaborate on a software development project.

In optional step 220 (illustrated in phantom), the processing system may receive, from the individual, a confirmation that the individual has begun reviewing the code change. For instance, where the notification sent in step 216 includes a button or other objects that include an embedded hyperlink to initiate a review process for reviewing the code change, the activation of the button or object by the individual may automatically trigger a confirmation message to be sent to the author of the code change. The method 200 may end in step 222.

Thus, examples of the present disclosure utilize artificial intelligence-based methods to generate a notification when a code review task is to be assigned. In one example, these methods may identify an individual to whom to assign a code review task based on an analysis of changed lines in the source code to be reviewed. These methods may then generate a notification to send to the individual, where the notification requests completion of the code review task by the individual. The notification may further provide the individual with a brief description of changes to the source code, an estimate of the amount of time necessary to perform a review of the source code, and/or an explanation explaining why the code review task was assigned to the individual. By selecting the individual who is best suited to review the source code and providing that individual with the information contained in the notification, it is expected that the challenges faced by conventional code review processes (such as delays in review due to lack of familiarity with the source code and/or lack of awareness of the urgency of the review) can be significantly reduced. As a result, the final software product may be delivered more quickly and with fewer bugs, while making more efficient use of human resources.

Although not expressly specified above, one or more steps of the method 200 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, any one or more of the servers 104 or 126 or edge routers 128 or 130 of FIG. 1 (such as might be used to perform the method 200) could be implemented as illustrated in FIG. 3. As depicted in FIG. 3, the system 300 comprises a hardware processor element 302, a memory 304, a module 305 for generating notifications for delegating code review tasks, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for generating notifications for delegating code review tasks may include circuitry and/or logic for performing special purpose functions relating to analyzing code changes and identifying individuals who are best suited for reviewing the code changes. The input/output devices 306 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for generating notifications for delegating code review tasks can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for generating notifications for delegating code review tasks (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor, a request for a code change to be merged into a main repository for a source code;
determining, by the processing system based on an analysis of the code change, an estimated risk level of the code change;
predicting, by the processing system based on the analysis of the code change, an estimated amount of time needed to review the code change;
identifying, by the processing system based on the analysis of the code change and on an analysis of the request, an individual to whom to assign the code change for review;
generating, by the processing system, a notification that includes a description of the code change and the estimated amount of time; and
delivering, by the processing system, the notification to the individual.

2. The method of claim 1, wherein the request for the code change comprises a pull request, and wherein the pull request is a part of a code review process for a software program with which that the source code is associated.

3. The method of claim 1, wherein the request includes at least one of: a description of the code change, an origin branch of the code change in the source code, a target branch of the code change in the source code, a list of individuals who are authorized to approve or reject the request, or a markup showing changes to the source code that are introduced by the code change.

4. The method of claim 1, wherein the estimated risk level indicates a likelihood that a bug is present in the code change.

5. The method of claim 1, wherein the determining comprises providing data extracted from the request as input to a machine learning model that is trained to predict the estimated risk level, wherein the data extracted from the request comprises at least one of: an author of the code change, an individual to whom the request is directed for review of the code change, a timestamp indicating when the request was received by a ticketing system, a file attached to the request, or a line number in each file attached to the request.

6. The method of claim 5, wherein at least one of the following is provided as a further input to the machine learning model: an author of a code change contained in a historical request received by the ticketing system, an individual to whom the historical request was directed for review of the code change contained in the historical request, a timestamp indicating when the historical request was received by the ticketing system, a file attached to the historical request, or a line number in each file attached to the historical request.

7. The method of claim 6, wherein at least one of the following is provided as a further input to the machine learning model: a work item type associated with the request, a bug status of the request, a severity of any bugs that have been automatically detected in the code change, a security issue that has been automatically detected in the code change, or a severity of a security issue detected by a security scan tool.

8. The method of claim 1, wherein the determining is based at least in part on at least one of: a presence of bugs in historical instances of source code that are directed to a same field of technology or a same function as the code change, a number of different individuals who worked on the code change, a type of technology to which the source code is directed, or whether a security scan tool has reported an open issue in the code change.

9. The method of claim 1, wherein the estimated amount of time is calculated based on a number of lines of code that are changed in the code change and a file type of the code change.

10. The method of claim 1, wherein the identifying comprises ranking a plurality of individuals to whom the code change can be assigned, wherein the individual to whom the notification is delivered is one of the plurality of individuals.

11. The method of claim 10, wherein the identifying further comprises identifying, subsequent to the ranking, a highest ranked individual of the plurality of individuals whose current workload does not exceed a threshold number of code review tasks, and wherein the highest ranked individual of the plurality of individuals whose current workload does not exceed the threshold number of code review tasks is the individual to whom the notification is delivered.

12. The method of claim 11, further comprising:
delivering, by the processing system to an author of the code change, a recommendation, wherein the recommendation suggests at least one individual to whom to send the request, and wherein the at least one individual includes the highest ranked individual of the plurality of individuals whose current workload does not exceed the threshold number of code review tasks.

13. The method of claim 12, further comprising:
receiving, by the processing system from the author of the code change, an authorization to send the request to a selected individual of the at least one individual, wherein the selected individual is the individual to whom the notification is delivered.

14. The method of claim 1, wherein the description of the code change is generated using a generative machine learning technique that takes as an input a description of the code change that is provided in the request and generates as an output the description of the code change that describes why changed lines of code in the code change were changed, and what the changed lines of code are intended to accomplish.

15. The method of claim 14, wherein the description of the code change further includes a number of lines of code that have been changed in the code change.

16. The method of claim 1, wherein the notification further includes an explanation as to why the individual was selected to review the code change.

17. The method of claim 1, wherein the notification further includes an object that includes an embedded hyperlink, wherein the embedded hyperlink, when activated, initiates a review process for reviewing the code change.

18. The method of claim 17, further comprising:
receiving, by the processing system, a confirmation that the individual has begun reviewing the code change in response to an activation of the embedded hyperlink by the individual.

19. A non-transitory computer-readable medium storing instructions which, when executed by a processing system including at least one processor, cause the processing system to perform operations, the operations comprising:
detecting a request for a code change to be merged into a main repository for a source code;
determining, based on an analysis of the code change, an estimated risk level of the code change;
predicting, based on the analysis of the code change, an estimated amount of time needed to review the code change;
identifying, based on the analysis of the code change and on an analysis of the request, an individual to whom to assign the code change for review;
generating a notification that includes a description of the code change and the estimated amount of time; and
delivering the notification to the individual.

20. A system comprising:
a processing system including at least one processor; and
a non-transitory computer-readable medium storing instructions which, when executed by the processing system, cause the processing system to perform operations, the operations comprising:
detecting a request for a code change to be merged into a main repository for a source code;
determining, based on an analysis of the code change, an estimated risk level of the code change;
predicting, based on the analysis of the code change, an estimated amount of time needed to review the code change;
identifying, based on the analysis of the code change and on an analysis of the request, an individual to whom to assign the code change for review;
generating a notification that includes a description of the code change and the estimated amount of time; and
delivering the notification to the individual.
